(19) United States
(12) Patent Application Publication
(10) Pub. No.: US 2026/0157358 A1
(43) Pub. Date: Jun. 11, 2026

(54) FISHING BOBBER WITH WEIGHT RECEIVING PORT

(71) Applicant: Eric Vaughn, Plattsmouth, NE (US)

(72) Inventor: Eric Vaughn, Plattsmouth, NE (US)

(21) Appl. No.: 18/973,893

(22) Filed: Dec. 9, 2024

(51) Int. Cl. A01K 93/00

(52) U.S. Cl. CPC A01K 93/00

(57) ABSTRACT

A fishing bobber can include a buoyant body having a relative density less than that of water, a top end of the body configured to float above the water surface, and a bottom end of the body configured to be submerged beneath the water surface. The fishing bobber can also include a channel defined through the body from the top end of the body to the bottom end of the body for slidably receiving a fishing line therethrough, and a port defined by the channel at the bottom end of the body for receiving a weight connectable to the fishing line. The fishing bobber can also include another port defined by the channel at the top end of the body for receiving at least one of a bead or a stopper connected to the fishing line.

### BACKGROUND

Fishing is the activity of attempting to catch fish. Fish can be caught in bodies of water in the natural environment (freshwater, marine) and also from stocked bodies of water, such as ponds and reservoirs.

### DRAWINGS

The Detailed Description is described with reference to the accompanying figures. The use of the same reference numbers in different instances in the description and the figures may indicate similar or identical items.

FIG. 1 is a side view illustrating a typical fishing bobber slidably fixed to a fishing line between a stopper and a weight, where a fish hook at the end of the fishing line is being cast into water and has become entangled on the fishing line and fishing bobber.

FIG. 2 is a side view of the typical fishing bobber illustrated in FIG. 1 after it has been cast and is floating at the surface of the water, where the fish hook is entangled on the fishing line and fishing bobber.

FIG. 3 is a side view illustrating a fishing bobber slidably fixed to a fishing line between a stopper and a weight, where a fish hook at the end of the fishing line is being cast into water, and the weight has been received by the fishing bobber preventing the fish hook from becoming entangled on the fishing line and fishing bobber in accordance with example embodiments of the present disclosure.

FIG. 4 is a side view of the fishing bobber illustrated in FIG. 3 after it has been cast and is floating at the surface of the water, where the fish hook has been pulled to a desired depth by the weight.

FIG. 5 is an exploded cross-sectional side elevation view illustrating a fishing bobber with a bead and a weight for being received by the fishing bobber in accordance with example embodiments of the present disclosure.

FIG. 6 is a cross-sectional side elevation view illustrating another fishing bobber in accordance with example embodiments of the present disclosure.

### DETAILED DESCRIPTION

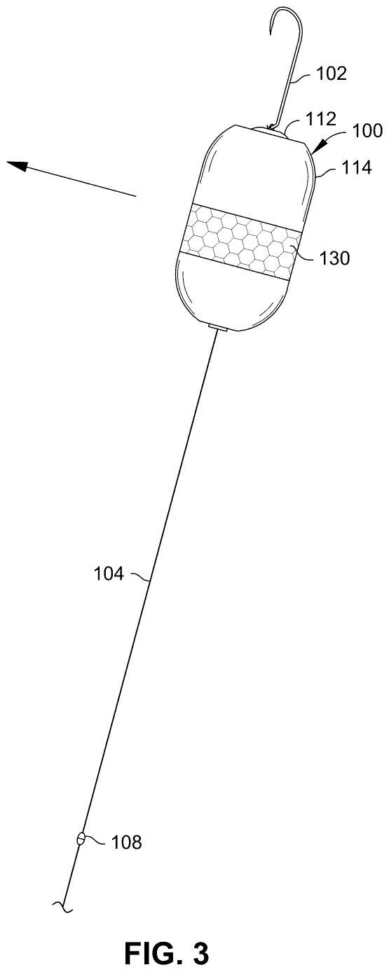

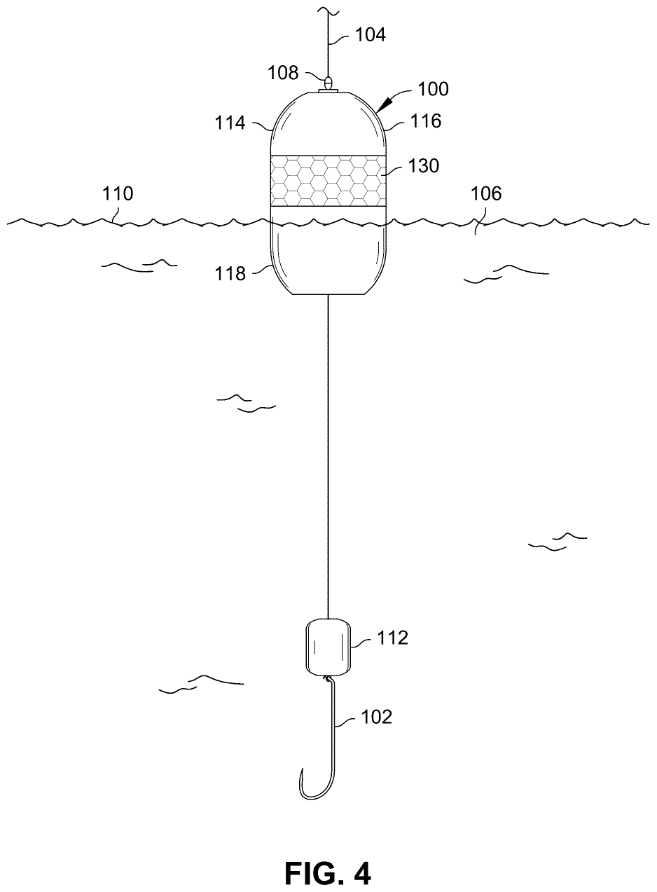

Referring generally to FIGS. 3 through 6, fishing bobbers 100 are described. A fishing bobber 100 (also referred to as a float) can be used in angling, or fishing using a fish hook 102 attached to a fishing line 104 to catch fish in water 106. The fish hook 102 is configured to catch a fish by piercing and embedding inside the mouth of the fish. Typically, the fishing line 104 is connected to a fishing rod or pole (sometimes by a reel) and is thrown (cast) into the water 106 by manipulating the fishing rod to deposit the fish hook 102 into an area of water selected for fishing. The fisherman then waits for a fish to approach the fish hook 102 and bite or swallow the hook. Oftentimes, bait will be added to the fish hook 102 to attract a fish and entice the fish into swallowing the hook. In some cases, bait can be food used to attract fish, while in other cases, bait can be an imitation of food with one or more attached fish hooks 102 (referred to as a lure).

The fishing bobber 100 is a lightweight buoy (i.e., relatively less dense than the water 106) that can be attached to the fishing line 104 between the fishing pole and the fish hook 102. The fishing bobber 100 can be used to suspend the fish hook 102 at a predetermined depth within the water 106, helping the fisherman target fish at that particular depth. The fishing bobber 100 can also serve as a visual indicator that alerts the fisherman to a bite on the fish hook 102, indicating when to start retrieving the hook to collect a fish from the end of the fishing line 104. The fishing bobber 100 can also be used to carry the fish hook 102 into an otherwise inaccessible area of water 106, e.g., by drifting along with a prevailing current. Further, the fishing bobber 100 can add mass to the end of the fishing line 104, allowing the fish hook 102 to be cast farther out across the water 106.

A stopper 108, which may be used with a bead in some instances, can be added to the fishing line 104 to control the depth of the fish hook 102 under the water surface 110 after casting. For example, a stopper 108 is attached to the fishing line 104 between the fishing bobber 100 and the fishing pole. The stopper 108 can be a rubber stopper, a knotted length of yarn, a knotted length of woven (e.g., braided) polyester, and so forth. A bead may be positioned on the fishing line 104 between the stopper 108 and the fishing bobber 100. A weight (e.g., a lead weight, a tungsten weight 112), also referred to as a “sinker,” can also be added to the fishing line 104 proximate to the fish hook 102 to cause the fish hook 102 to sink to the desired depth in the water 106, e.g., as determined by the placement of the stopper 108. For example, the fishing bobber 100 can be configured as a slip bobber, where the fishing line 104 can slide through the fishing bobber 100, allowing the fishing line 104 to play out as the weight causes the fish hook 102 to sink to the desired depth in the water 106 until stopped by the stopper 108.

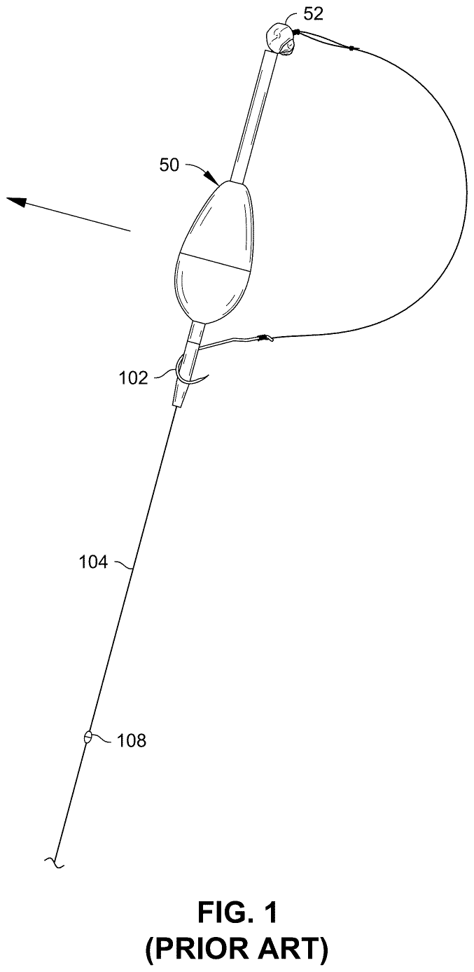

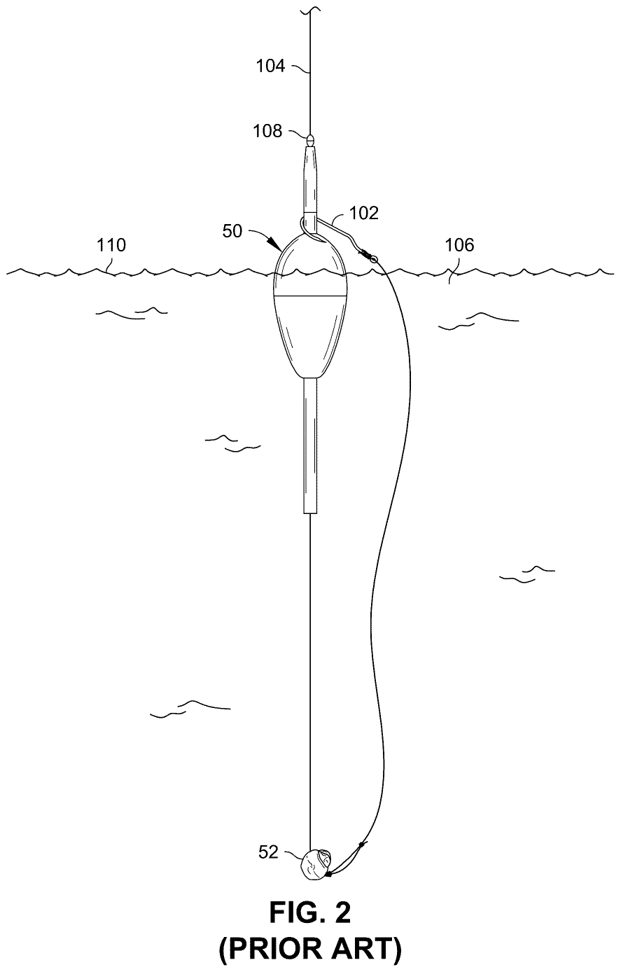

With reference to FIGS. 1 and 2, when casting a typical fishing bobber 50, a fish hook 102 often becomes entangled on the typical fishing bobber 50 and/or the fishing line 104. For example, typical fishing bobbers 50 are generally quite light and have a thin, elongate profile. When casting, the fish hook 102 can swing around at the end of the fishing line 104 as there is a great deal of play at the end of the line. For example, a lead weight 52 can rotate at the end of the fishing line 104 relative to the typical fishing bobber 50, throwing the fish hook 102 about and increasing the chances that the fish hook 102 swings around and onto or near the fishing line 104. This can cause the fish hook 102 to become tangled on the fishing line 104 and/or the typical fishing bobber 50. Compounding the problems presented by these scenarios, it may not be easy for a fisherman to determine the fish hook 102 has become tangled, as the typical fishing bobber 50 may be far enough away from the fisherman to make visual inspection of the typical fishing bobber 50 difficult or impossible.

Referring again to FIGS. 3 through 6, a fishing bobber 100 for receiving a fishing line 104 and floating at a water surface 110 includes a buoyant body 114 having a relative density (i.e., specific gravity) less than that of the water 106. For example, the body 114 of the fishing bobber 100 can be polymeric material, such as plastic material (e.g., injection molded, 3D printed), cellulosic material, such as wood (e.g., balsa wood), and so forth. In some embodiments, the body 114 can be constructed of multiple materials joined (e.g., glued, sonic welded, co-molded) together. In some embodiments, the body 114 can be of unitary construction, e.g., fabricated using a single material such as injection-molded plastic.

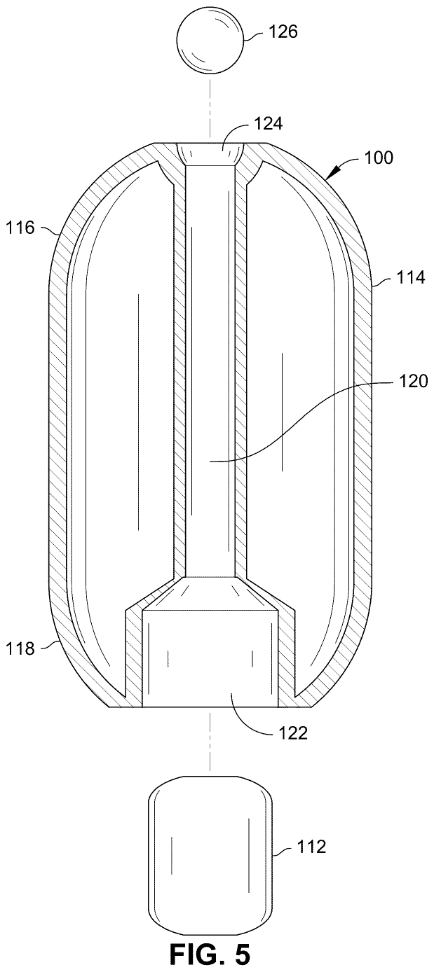

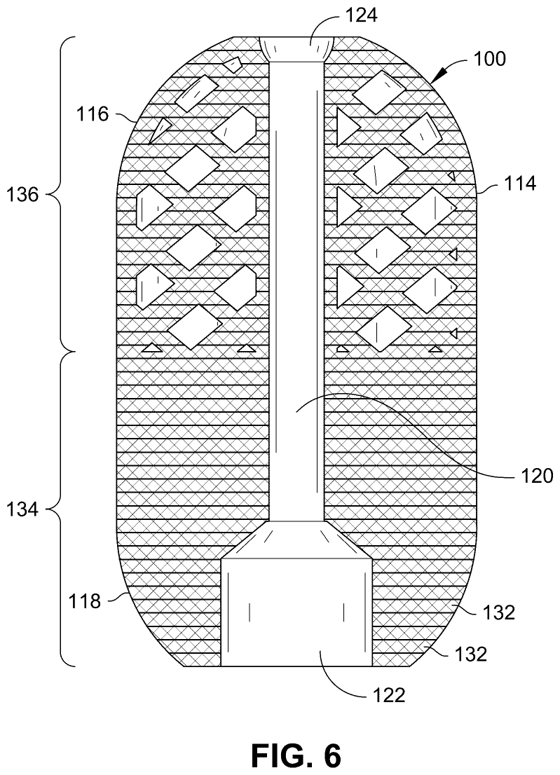

The body 114 of the fishing bobber 100 has a top end 116 configured to float above the water surface 110, and a bottom end 118 configured to be submerged beneath the water surface 110. In some embodiments, the top end 116 of the body 114 has a relative density less than that of the bottom end 118 of the body 114. For example, the top end 116 of the body 114 can be fabricated from a relatively less dense material such as balsa wood, while the bottom end 118 of the body 114 can be fabricated from a relatively more dense material such as hardwood. In other examples where the body 114 is of unitary construction, the top end 116 of the body 114 can be hollow and/or a lattice or matrix of material, while the bottom end 118 of the body 114 can be solid and/or a more dense lattice or matrix of material (e.g., as illustrated in FIG. 6) In some embodiments, the body 114 of the fishing bobber 100 can be hollow throughout (e.g., as illustrated in FIG. 5).

The fishing bobber 100 has a channel 120 defined through the body 114 from the top end 116 of the body 114 to the bottom end 118 of the body 114 for slidably receiving a fishing line 104, e.g., in the manner of a slip bobber. In embodiments, the fishing bobber 100 has a cavity or port 122 defined by the channel 120 at the bottom end 118 of the body 114 for receiving a weight (e.g., a lead weight, a tungsten weight 112) connectable to the fishing line 104. As described, the port 122 receives the weight when the fishing line 104 is cast. For example, as shown in FIG. 3, the casting motion on the fishing line 104 forces the fishing bobber 100 toward the end of the line, and the fishing bobber 100 receives the tungsten weight 112 in the port 122. Thus, the casting action serves to consolidate the fishing bobber 100 and the tungsten weight 112 together at the end of the fishing line 104, preventing the tungsten weight 112 from throwing the fish hook 102 about and onto the fishing line 104. It should be noted that the consolidation of the fishing bobber 100 and the tungsten weight 112 at the end of the fishing line 104 can also improve casting distance. It should be noted that in some instances, another stopper and possibly a bead may be positioned between the fish hook 102 and the weight/sinker, e.g., to provide a stop for the weight.

In some embodiments, the fishing bobber 100 also has another cavity or second port 124 defined by the channel 120 at the top end 116 of the body 114. In some embodiments, the second port 124 is configured for receiving a stopper 108 and/or a bead 126 (FIG. 5) on the fishing line 104. When the stopper 108 or bead 126 is received in the second port 124, the fisherman can receive audible and/or tactile feedback (e.g., the sound and/or feel of a “click” on the line), indicating that the weight has successfully deployed the fish hook 102 beneath the water surface 110. For example, the bead 126 can be a glass bead that makes an audible click when it impacts the fishing bobber 100. In some embodiments, the channel 120 can be configured for receiving a bushing or tubing that provides a smooth surface for the fishing line 104 to wear against as the fishing line 104 moves along the channel 120 through the bushing or tubing. For example, the bushing or tubing can be formed of polymeric material, such as a synthetic fluoropolymer (e.g., polytetrafluoroethylene (PTFE) tubing material). In another example, the bushing or tubing can be formed of metal material, such as brass. The bushing or tubing can be inserted through the second port 124 and extend through the channel 120 (or a portion thereof).

The fishing bobber 100 can include a reflective surface 130, such as a reflective coating (e.g., paint), a reflective tape, and so forth for enhancing the visibility of the fishing bobber 100 to the fisherman. The reflective surface 130 can extend around the fishing bobber 100. As shown and described with reference to the accompanying figures, in some embodiments the fishing bobber 100 can have generally squat rectangular shape, with an aspect ratio (ratio of height to width) ranging from about 2:1 to about 1:1, e.g., about one and three-quarters (1.75) to one (1). Without wishing to be bound by any particular theory or principle of operation, the squat shape of the fishing bobber 100 may also aid in preventing the fish hook 102 from swinging around and onto or near the fishing bobber 100 and/or the fishing line 104.

In some embodiments, the fishing bobber 100 is formed using an additive manufacturing process. For example, the fishing bobber 100 is formed using a 3D printer that enables complex shapes, such as the interior channel 120 and ports 122 and/or 124. In some embodiments, the fishing bobber 100 can be formed using a 3D printer process that uses polylactic acid (PLA) material. However, it should be noted that PLA is provided by way of example and is not meant to limit the present disclosure. In other embodiments, the fishing bobber 100 can be formed (e.g., 3D printed) using other materials, including, but not necessarily limited to: other plastic materials (e.g., acrylonitrile butadiene styrene (ABS) materials), nylon materials, carbon fiber materials, resin materials (e.g., flexible resin material), and so forth.

With reference to FIG. 6, the fishing bobber 100 can be constructed (e.g., 3D printed) with multiple layers 132 of a polymeric material each successively deposited one on another. For example, a first set 134 of layers 132 and a second set 136 of layers 132 are deposited using a 3D printing process. As described, the first set 134 of layers 132 can be deposited as a solid fill, and the second set 136 of layers 132 can be deposited as a hollow fill, e.g., where the first set 134 of layers 132 is deposited at the bottom end 118 of the body 114, and the second set 136 of layer 132 is deposited at the top end 116 of the body 114. For the purposes of the present disclosure, the term “hollow fill” shall be understood to mean a hollow structural arrangement (e.g., as depicted in FIG. 5) or a partially filled arrangement, such as a lattice or matrix of material (e.g., as depicted in FIG. 6). For instance, the hollow fill can be a fill of cross-sectional triangle shapes filling between about five percent (5%) and about twenty percent (20%) of the material space. Correspondingly, the term “solid fill” shall be understood to mean a solid structural arrangement or a lattice or matrix of material more dense than a corresponding hollow fill (e.g., as illustrated in FIG. 6). It should be noted that a hollow fill with repeating cross-sectional shapes, such as the aforementioned triangles, may serve to create individual chambers, enhancing the buoyancy and resilience of the fishing bobber 100.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A fishing bobber for receiving a fishing line and continuously floating at a water surface, the fishing bobber comprising:
a buoyant body having a relative density less than that of water;
a top end of the body configured to float above the water surface;
a bottom end of the body configured to be submerged beneath the water surface;
a channel defined through the body from the top end of the body to the bottom end of the body for slidably receiving a fishing line therethrough;
a first port defined by the channel at the bottom end of the body and sized for slidably receiving a weight connectable to the fishing line; and
a second port defined by the channel at the top end of the body for receiving at least one of a bead or a stopper connected to the fishing line, wherein the channel is defined by a first cylindrical wall forming the first port and a second cylindrical wall proximate to the second port, the first cylindrical wall having a greater diameter than the second cylindrical wall and configured to retain the weight so a first end of the weight protrudes from the body when the fishing bobber is cast and allow the weight to slide out of the fishing bobber and sink when the fishing bobber is floating at the water surface.

2. The fishing bobber as recited in claim 1, wherein the body of the fishing bobber is hollow throughout.

3. The fishing bobber as recited in claim 1, wherein the top end of the fishing bobber has a relative density less than the bottom end of the fishing bobber.

4. The fishing bobber as recited in claim 3, wherein the top end of the fishing bobber is at least one of hollow or comprises a first lattice or matrix of material, and the bottom end of the fishing bobber is at least one of solid or comprises a second lattice or matrix of material more dense than the top end of the fishing bobber.

5. The fishing bobber as recited in claim 1, wherein the body is constructed of a plurality of layers of a polymeric material each successively deposited one on another.

6. The fishing bobber as recited in claim 5, wherein a first set of the plurality of layers of the polymeric material is a solid fill and a second set of the plurality of layers of the polymeric material is a hollow fill proximate to the top end of the body.

7. A fishing bobber for receiving a fishing line and continuously floating at a water surface, the fishing bobber comprising:
a buoyant body having a relative density less than that of water;
a top end of the body configured to float above the water surface;
a bottom end of the body configured to be submerged beneath the water surface;
a channel defined through the body from the top end of the body to the bottom end of the body for slidably receiving a fishing line therethrough; and
a port defined by the channel at the bottom end of the body and sized for slidably receiving a weight connectable to the fishing line, wherein the channel is defined by a first cylindrical wall forming the port and a second cylindrical wall distal to the port, the first cylindrical wall having a greater diameter than the second cylindrical wall and configured to retain the weight so a first end of the weight protrudes from the body when the fishing bobber is cast and allow the weight to slide out of the fishing bobber and sink when the fishing bobber is floating at the water surface.

8. The fishing bobber as recited in claim 7, further comprising a second port defined by the channel at the top end of the body for receiving at least one of a bead or a stopper connected to the fishing line.

9. The fishing bobber as recited in claim 7, wherein the body of the fishing bobber is hollow throughout.

10. The fishing bobber as recited in claim 7, wherein the top end of the fishing bobber has a relative density less than the bottom end of the fishing bobber.

11. The fishing bobber as recited in claim 10, wherein the top end of the fishing bobber is at least one of hollow or comprises a first lattice or matrix of material, and the bottom end of the fishing bobber is at least one of solid or comprises a second lattice or matrix of material more dense than the top end of the fishing bobber.

12. The fishing bobber as recited in claim 7, wherein the body is constructed of a plurality of layers of a polymeric material each successively deposited one on another.

13. The fishing bobber as recited in claim 12, wherein a first set of the plurality of layers of the polymeric material is a solid fill and a second set of the plurality of layers of the polymeric material is a hollow fill proximate to the top end of the body.

14. A fishing bobber system for receiving a fishing line and continuously floating at a water surface, the fishing bobber system comprising:
a weight connectable to the fishing line;
a buoyant body having a relative density less than that of water;
a top end of the body configured to float above the water surface;
a bottom end of the body configured to be submerged beneath the water surface;
a channel defined through the body from the top end of the body to the bottom end of the body for slidably receiving a fishing line therethrough; and
a port defined by the channel at the bottom end of the body and sized for slidably receiving the weight connectable to the fishing line, wherein the channel is defined by a first cylindrical wall forming the port and a second cylindrical wall distal to the port, the first cylindrical wall having a greater diameter than the second cylindrical wall and configured to retain the weight so a first end of the weight protrudes from the body when the fishing bobber is cast and allow the weight to slide out of the fishing bobber and sink when the fishing bobber is floating at the water surface.

15. The fishing bobber system as recited in claim 14, further comprising a second port defined by the channel at the top end of the body for receiving at least one of a bead or a stopper connected to the fishing line.

16. The fishing bobber system as recited in claim 14, wherein the body of the fishing bobber is hollow throughout.

17. The fishing bobber system as recited in claim 14, wherein the top end of the fishing bobber has a relative density less than the bottom end of the fishing bobber.

18. The fishing bobber system as recited in claim 17, wherein the top end of the fishing bobber is at least one of hollow or comprises a first lattice or matrix of material, and the bottom end of the fishing bobber is at least one of solid or comprises a second lattice or matrix of material more dense than the top end of the fishing bobber.

19. The fishing bobber system as recited in claim 14, wherein the body is constructed of a plurality of layers of polymeric material each successively deposited one on another.

20. The fishing bobber system as recited in claim 19, wherein a first set of the plurality of layers of the polymeric material is a solid fill and a second set of the plurality of layers of the polymeric material is a hollow fill proximate to the top end of the body.
